(19) United States
(12) Patent Application Publication
(10) Pub. No.: US 2015/0176681 A1
(43) Pub. Date: Jun. 25, 2015

(54) LANTERN-TYPE PLANETARY GEARING

(71) Applicant: IWIS MOTORSYSTEME GMBH & CO. KG, München (DE)

(72) Inventors: Michael Frank, Otterfing (DE); Reinhard Müller, Landsberg (DE); Christoph Lunk, Munchen (DE)

(21) Appl. No.: 14/414,024

(22) PCT Filed: Nov. 14, 2012
(86) PCT No.: PCT/EP2012/004727

§ 371 Date: Jan. 9, 2015

(30) Foreign Application Priority Data
Jul. 9, 2012 (DE) 102012013637.4

(51) Int. Cl. F16H 1/34; F16H 7/06; F16H 55/10

(52) U.S. Cl. CPC F16H 1/34; F16H 55/10; F16H 7/06

(57) ABSTRACT

An epicyclic gearing, particularly a planetary gearing, has at least two central wheels and at least one planet wheel, whereby the at least one planet wheel engages simultaneously with two central wheels in order to transmit a movement of the one central wheel to the other central wheel. The at least two central wheels are thereby formed as lantern elements and the at least one planet wheel is formed as a lantern wheel. Alternatively, the at least one planet wheel is formed as a lantern element and the at least two central wheels are formed as lantern wheels.

The present invention relates to an epicyclic gearing, particularly to a planetary gearing, having at least two central wheels and at least one planet wheel, whereby the at least one planet wheel engages simultaneously with two central wheels in order to transmit a movement of the one central wheel on to the other central wheel.

Conventional epicyclic gearings can be formed as toothed gears or as friction gears, the epicyclic gearings having stationary axles, which do not change their position in the gear housing, and revolving axles, which move on circular paths in the frame. In many embodiments, the revolving axles are arranged parallel to the axles fixed to the frame, wherein the gear wheels rotating on the revolving axles revolve around an assigned central wheel, which is arranged in the gear centre, in a manner similar to a planet. Epicyclic gearings are compactly constructed gears, because the wheels rotating in the frame are generally coaxial.

An epicyclic gearing has at least two shafts held stationary with regard to the frame as well as a revolving shaft, and, unlike single one-stage stationary gears, it always has at least two gear stages. The gear wheels arranged to the stationary shafts are called central gear wheels. These central wheels rotate in a stationary position to the frame. The gear wheels arranged on revolving shafts are called planet gear wheels. The revolution of the at least one planet wheel is coaxial with the two revolted central wheels, so that the axis of a respective planet wheel carrier carrying the at least one or more planet wheels is coaxial with the axes of the central wheels. Different designs of epicyclic gearings result from the different shapes of the central wheels and the number of planet wheels. If the outer central wheel is an annulus wheel, it is possible to implement a particularly narrow epicyclic gearing or planetary gearing.

In the case of a direct forced transmission for an epicyclic gearing, one of the three shafts, the two central shafts and the planet carrier shaft, is fixed, so that in the case of such a two-shaft operation the speed of the free-running shaft is defined, when the powered shaft is driven with a certain speed. The transmission of the gear is thereby always determined by the relationship between the rotational speeds that is by the relationship between the teeth of the two central wheels. In the case of a three-shaft operation, the gear no longer works in a forced manner, and can instead act as a summation gear or a distribution gear. In the case of a summation gear, two shafts can be used for powering the gear system and one shaft is driven, for example for use in hybrid drives. In contrast, in the case of a distribution gear, one shaft is used for powering and two shafts are driven, whereby the relationship between the rotational speeds of the two driven shafts is defined by the gear system. The differential gear in common motor vehicles is a known example of a distribution gear.

Conventional epicyclic gearings, and particularly planetary gearings with a central sun wheel and a centrally rotating outer annulus wheel which are used for torque division, require precise construction and also a high level of precision during the manufacturing of the central wheels and planet wheels, in order for an exact operation with the lowest possible friction. The complex manufacture of toothed wheels of planetary gearings with gear toothing that is repeatedly precision-grounded leads to high production costs for such torque-dividing gear constructions.

Therefore, the object of the present invention is to provide an economical gear system construction for torque division.

This object is solved according to the present invention by means of an epicyclic gearing in that the at least two central wheels, i.e. the sun wheel and the outer annulus wheel, are formed as lantern elements and the at least one planet wheel is formed as a lantern wheel, or in that the at least one planet wheel is formed as a lantern element and the at least two central wheels are formed as lantern wheels. Due to the use of lantern elements and lantern wheels in an epicyclic gearing or in a planetary gearing, it is possible to eliminate completely the complex manufacture of precision-grounded or tensed toothed wheels. As a result of which a main cost share of the production of torque-dividing gears can be saved. The lantern elements thereby principally consist of two rigid elements, that are arranged parallel and spaced apart from each other, and which exert a force-deflecting function in the case of contact with another rigid element moving relative thereto and, depending on the contact angle regarding the movement, carry out wedged force intensification. This function can be fulfilled by, for example, arrangements of circular or elliptical components that are provided with bolts at periodic intervals, which are welded or riveted into the associated bore holes of the flat components. The bolts that are arranged perpendicularly to and between the two flat circular or elliptical components form a type of horizontal-aligned ladder into which a lantern wheel engages, such as a sprocket-like lantern wheel. The sprocket-like lantern wheel exerts an essentially radial movement on the lantern element and consequently diverts the force tangentially.

In contrast to a milled and ground toothed wheel, a lantern wheel and the lantern elements can be manufactured in a very much simpler manner, for example by means of stamping components and simple trimming of bolts. Despite of the replacement of the precision-grounded toothed wheels, which are normally used as central wheels and planet wheels in epicyclic gearings or planetary gearings, with simple chain-like lantern components, the construction according to the invention satisfies all the criteria of an epicyclic gearing. The transmission ratio or rotational speed ratio is determined by the number of bolts of the lantern elements, which are used as central wheels, and by the number of teeth of the lantern wheels, used as central wheels. During force deflection in an epicyclic gearing according to the present invention, the bolts of the lantern elements mainly undergo shearing stress, so that it is possible to reduce the wear on the teeth that otherwise occurs in common epicyclic gearing.

In the conventional use, lantern components are used for slow drive elements in environments with high pollution levels, for example in mining, where even large amounts of pollutant are not permitted to cause disorders in a drive. In addition to the restriction to only comparatively low drive speeds, lantern teeth systems can also transmit only relative small forces, because the lantern wheel in conventional applications is strongly rounded on the base circle and the base of the gear toothing is consequently weakened. In contrast to this, in the case of use in an epicyclic gearing according to the present invention, lantern elements and lantern wheels are used both for high speeds and also for relatively high forces.

For exclusive use as a transmission gear, the at least two central wheels of the epicyclic gearing can be formed as coaxial central wheels that rotate stationary connected stationary to the frame. Additionally, for better synchronisation of the gear and low wear on the individual components, at least two planet wheels, preferably at least three planet wheels, can be used. The at least two planet wheels can advantageously be arranged in the epicyclic gearing such that they are engaged with the two central wheels, but out of phase by a few degrees with respect to one another. This phase offset in the arrangement of the planet wheels can minimise the contact forces that arise during the engagement and, due to the reduction in the oscillations and noises in the gear, lead to improved NVH behaviour.

A simple embodiment provides for the lantern elements to have at least two support plate plates as well as a plurality of bolts, whereby the bolts are mounted in the support plates at periodic intervals on a circling track around the axis of the respective lantern element in such a manner that the support plates are arranged spaced apart from one another in a parallel manner. This simple configuration of the lantern elements for an epicyclic gearing according to the present invention allow synergetic use of chain bolts from the manufacture of conventional high-performance silent chains that are joined appropriately to the support plate with common joining methods and procedures, typically riveting, known from silent chain manufacture. In this way a solid and very exact lantern element can be made, which may also be used in epicyclic gearings in the event of high speeds and high force transmissions.

A preferred embodiment provides for the lantern elements to have at least two base support plates and a plurality of chain bushings, wherein the chain bushings are arranged at periodic distances on a circular path around the axis of the respective lantern element between the support plates, in order to arrange the support plates spaced apart from one another in a parallel manner. To attach the chain bushings to the support plates, chain bolts can extend through each chain bushing and be connected to the support plates. The use of the chain bushings arranged at periodic distances between the flat support plates, which are formed as rings or circles, allows a constant distance between the support plates, so that they are arranged parallel to one another. The chain bushings can thereby be joined directly to the support plate, in accordance with the configuration of conventional inner chain links, or by means of additional chain bolts that are connected to the support plate and that extend through the chain bushings. Such lantern elements provide a simple chain-like configuration and are, as a result, suitable for the transmission of higher speeds and greater forces than conventional lantern components.

An expedient development provides for the lantern elements to have at least one support plate and a plurality of inner chain links, whereby the inner chain links are attached to the support plate in a ring-shape manner around the axis of the respective lantern element, each inner chain link has two chain link plates and two chain bushings that connect the plates at a parallel distance apart from each other. The use of already pre-assembled components from the field of the manufacture of high-performance silent chains provides corresponding synergy effects, which result in savings during the manufacture and assembly of the lantern elements. The inner chain links can thereby be attached to a flat, circular support base plate by bolts in a simple chain-like manner, without impairing the precision of the inner chain links manufactured as a mass-production component. Here again a chain-like configuration of the lantern elements is due, that accordingly may be used for higher speeds and for the transmission of greater forces.

The lantern elements of the epicyclic gearing according to the present invention may advantageously have a plurality of chain rollers, whereby the chain rollers are arranged such that they can rotate around the chain bolts or the chain bushings. Similarly to the use of chain rollers in the field of high-performance silent link chains, the use of the chain rollers, rotating around the chain bolts or the chain bushings, reduces the wear on the chain-like lantern element as well as on the chain-wheel-like lantern wheel that engages with the same. In addition to the improved wear, the use of chain rollers in addition to chain bushings generally has a positive acoustic effect and furthermore allows tolerance compensation. Lantern elements with chain rollers are therefore also suitable for use at high speeds and very large forces.

Equivalent to the design of the lantern elements as chain component, the lantern wheels can also be formed as chain wheels, which allow reliable as well as low-wear and low-noise engaging into the chain-like lantern elements. It is thereby also possible in the manufacture of the lantern wheels that are formed as chain wheels to make use of synergy effects with known manufacturing methods from the field of high-performance chain drives, whereby these synergy effects have a positive influence on the precision and functionality of the lantern wheels, as well as on the manufacturing costs. Due to the experience from the field of high-performance silent drive chains, the lantern wheels, which can be strongly rounded on the base circle depending on the design of the epicyclic gearing, may also be manufactured in a corresponding strength in order to stand up to the high speeds and high force transmissions in epicyclic gearings and planetary gearings.

For a design as a pure planetary gearing, a central wheel may be formed as a sun wheel that is formed from chain elements and engaged from the outside, while the other central wheel maybe formed as an annulus wheel that is likewise formed from chain elements, but engaged from the inside. The construction as a pure planetary gearing allows a particularly narrow gear structure and, as a result, the use for driving motorized two-wheelers. Furthermore, the at least one planet wheel can revolve around the axis of the at least two central wheels, so that the axis of the planet wheel is not fixed with respect to the frame of the gear. Therefore both shafts of the at least two central wheels and also the planet carrier shaft are formed coaxially and may be used as a driving shaft or as a driven shaft, so that the epicyclic gearing according to the invention in a three-shaft operation may be used as a summation gear or distribution gear. Thus, such gears accordingly can be used to couple a plurality of drives to one driven unit, such as used in hybrid drives or in electric bicycles.

An embodiment of the invention is explained in more detail in the following. Shown are:

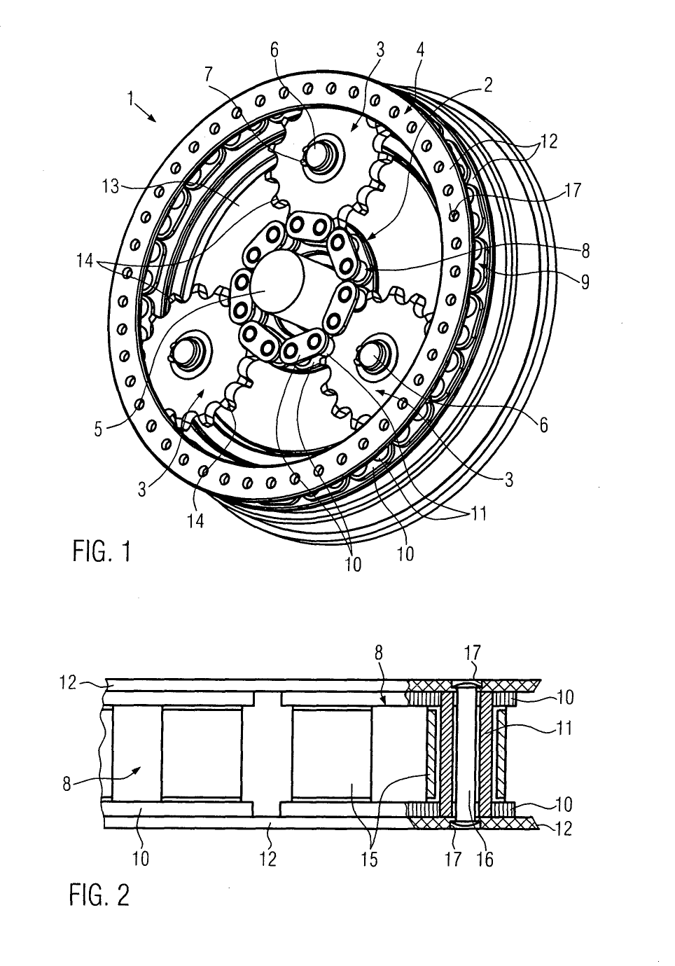

FIG. 1 a perspective view of an epicyclic gearing according to the invention; and

FIG. 2 a partially cut-open side view of a part of a lantern element from FIG. 1.

The perspective view of an epicyclic gearing 1 according to the invention in FIG. 1 shows a planetary gearing with a central sun wheel 2, three planet wheels 3 that revolve around the sun wheel 2, and an annulus ring wheel 4. The sun wheel 2 and the annulus wheel 4 are coaxial as central wheels, whereby the sun wheel 2 is in contact with the planet wheels 3 in an exterior engagement and the annulus wheel 4 is in contact with the planet wheels 3 in an interior engagement. The sun wheel 2 is connected to the sun wheel shaft 5 that projects from the sun wheel 2 in FIG. 1. The axes of the central sun wheel and of the annulus wheel 4 extend through the centre of the sun wheel shaft.

Each of the three planet wheels 3 shown in FIG. 1 is arranged on a freely-revolving planet wheel shaft 6 and is secured by means of a retaining ring 7. The axes of the revolving planet wheel shafts 6 extend parallel to the central axis of the sun wheel 2 and of the annulus wheel 4. For three-shaft operation of this planetary gearing, the planet wheels 3 or their planet wheel shafts 6 are connected to one another via a plurality of tabs or a planet carrier (not shown), so that the revolution of the planet wheels 3 can be gripped by means of a planet carrier shaft (not shown), whereby the planet carrier shaft is aligned such that it is coaxial with the sun wheel 2, or its sun wheel shaft 5, and the annulus wheel 4, or a corresponding annulus wheel shaft (not shown).

The sun wheel 2 in the embodiment of an epicyclic gearing 1 according to the present invention shown in FIG. 1 is constructed of seven inner chain links 8 that are arranged in a ring shape manner around the sun wheel shaft 5 on a flat, circular support plate 9. Each of the inner chain links 8 is formed from two link plates 10, which are arranged parallel to each other and at a distance apart from each other, and two chain bushings 11 that fix the link plates 10 at a distance apart from each other. The chain bushings 11 are thereby pressed into corresponding bore holes of the link plates 10, or are connected to one another by means of other common methods in the field of high-performance silent link chains. For the manufacture of an epicyclic gearing 1 according to the invention, the inner chain plates 8 are preferably provided as pre-assembled components from the field of the manufacture of high-performance silent chains. The single inner chain links 8 are thereby arranged on the support plate 9 in such a manner that the distance between two adjacent chain bushings 11 of two adjacent inner chain links 8 corresponds to the distance between the chain bushings 11 of a single inner chain link 8. Furthermore, all chain bushings 11 are spaced the same distance from the central axis of the sun wheel 2. The inner chain links 8 can be attached securely to the circular support plate 9 in various ways. With regard to the synergies with the field of high-performance silent chains, particularly chain bolts 16 may be used for this, whereby said chain bolts 16 extend through the chain bushings 11 and are joined to the base plate 9. For transmitting the movements and forces in the epicyclic gearing 1, the support plate 9 is connected to the sun wheel shaft 5.

The annulus wheel 4, which engages internally with the planet wheels 3, is also constructed from a plurality of ring-shaped inner chain links 8 that are arranged between two ring-shaped support plates 12. Here again, the distance between the chain bushings 11 of the individual inner chain links 8 is identical to the distance between adjacent chain bushings 11 of neighbouring inner chain links 8, and the distance between the chain bushings and the annulus wheel axis or the central axis of the gear 1 is also identical. Unlike the sun wheel 2, the annulus wheel 4 has two ring-shaped support plates 12, between which the inner chain links 8 are arranged and to which the inner chain links 8 are connected. A simple possibility for connecting the ring-shaped support plate 12 to the inner chain links 8 is assembly corresponding to the joining of high-performance silent link chains, in which chain bolts 16 extend internally through the chain bushings 11 and are riveted in corresponding bore holes of the ring-shaped support plate 12. To simplify the assembly, in the embodiment of an epicyclic gearing 1 shown in FIG. 1, the annulus wheel 4 is formed with two ring-shaped support plates 12 and attached to a shaft plate 13 that transmits the movement of the annulus wheel 4 and correspondingly all forces and moments on to the centrally arranged annulus wheel shaft (not shown) that is fixed to the frame. Alternatively, the construction of the annulus wheel 4 from a plurality of inner chain links 8 can take place directly on the shaft plate 13.

In the partially cut-open side view of the annulus wheel 4 in FIG. 2, the detailed configuration of the annulus wheel 4 can be seen clearly, which here is seen in a preferred construction of the lantern elements. Unlike the embodiment of the inner chain links 8 with outer-lying chain bushings 11 without additional chain rollers 15 shown in FIG. 1, in FIG. 2 an alternative, low-wear construction of the inner chain links 8 is shown. The inner chain links 8 are arranged between the ring-shaped support plates 12 of the annulus wheel 4. In this embodiment, next to the chain bushings 11 that are inserted between the chain plates 10 positioned spaced apart from one another in a parallel manner, chain rollers 15 are provided that are arranged such that they can rotate around the chain bushings 11. The use of chain rollers 15 in addition to chain bushings 11 or chain bolts 16 not only allows improved wear during the engagement of the respective lantern element in a lantern wheel, it also reduces the noise development and allows tolerance compensation. To attach the inner chain links 8 to the ring-shaped support plates 12, a chain bolt 16 extends through the corresponding bore holes 17 in the support plates 12 and through the chain bushings 11 of the chain links 8. The chain bolt 16 is thereby riveted on both ends in the bore holes 17 of the two support plates 12.

Between the sun wheel 2 and the annulus wheel 4, three planet wheels 3 are arranged, offset by roughly 120°, around the middle axis of the planetary gearing, whereby these planet wheels engage with their chain teeth 14 simultaneously into the sun wheel 2 and into the annulus wheel 4. A phase shift in the arrangement of the planet wheels 3 by a few degrees thereby allows a minimisation of the contact forces to the sun wheel 2 and annulus wheel 4, which consequently leads to a further reduction in the noises and oscillations that arise in the planetary gearing, and thus, to an improvement of the NVH behaviour of an assigned engine. The planet wheels 3, that are formed as conventional chain wheels, may be perfectly constructed with common design tools for chain wheels known from the field of high-performance silent chains and likewise manufactured with respective manufacturing methods known from the field of high-performance silent link chains, e.g., fine blanking. The internal engagement of the planet wheels 3 formed as chain wheels into the annulus wheel 4 is comparable to the guided engagement of a high-performance silent link chain into an internal chain wheel, while at the same time, the engagement between the sun wheel 2 and planet wheels 3 involves only very few teeth. The number of chain bushings 11 of the sun wheel 2 is therefore not permitted to be divisible by the number of planet wheels 3, in order to guarantee an offset engagement of the three planet wheels 3 into the sun wheel 2.

In addition to the configuration of a planetary gearing with the central wheels, i.e. the sun wheel 2 and annulus wheel 4, as lantern elements and the planet wheels 3 as lantern wheels as shown in FIG. 1, an inversion of the configuration of this epicyclic gearing 1 is also comprised according to the present invention. The sun wheel 2 and the annulus wheel 4 are then formed as cylindrical lantern wheels, while the planet wheels 3 are formed as lantern elements in a manner similar to the sun wheel 2 from FIG. 1.

The epicyclic gearing 1 shown in FIG. 1 and also a corresponding inverted configuration have the same driving and driven options as well as braking and freewheeling functions of conventional planetary gearings. The rotational speed ratio between the sun wheel 2 and the annulus wheel 4 thereby results, as do all other transmission ratios, from the number of chain bushings 11, or, in the inverted version, from the number of corresponding chain bolts 16, of the sun wheel 2 divided by the number of chain bushings 11 and chain bolts 16 respectively on the annulus wheel 4.

Instead of the chain bushings 11 of the inner chain links 8 shown in FIG. 1, it is also possible, as shown in FIG. 2, to provide chain rollers 15 in addition to the chain bushings 11, whereby these chain rollers 15 reduce, by rotation around the chain bushings 11 or chain bolts 16 during the engagement in the chain-wheel-like planet wheels 3, the wear on the chain teeth 14 and on the chain bushings 11, chain bolts 16, and chain rollers 15 respectively. The special development of the epicyclic gearing 1 according to the present invention with lantern elements and lantern wheels allows, during a force transmission from one of the centrally frame supported central wheels on to the planet wheels 3 and back again on to the other central wheel, the sun wheel 2 or annulus wheel 4, a force transmission in which the chain bushings 11 or interior or alternatively inserted chain bolts 16 essentially undergo shearing stress. This increases the loading capacity of the epicyclic gearing 1 and at the same time reduces the wear on the central wheels and planet wheels 3. With an epicyclic gearing 1 according to the present invention, it is possible to dispense precision-grounded toothing of central wheels and planet wheels, which otherwise is needed for any planetary gearings in order to reach a low-wear engagement of the toothed wheels.

1. An epicyclic gearing having two central wheels, a central sun wheel and a central ring wheel, and at least one planet wheel; the at least one planet wheel engages simultaneously with the two central wheels in order to transmit a movement of the one central wheel on to the other central wheel, wherein the at least one planet wheel is formed as a chain wheel;
wherein the two central wheels have at least one support plate, a plurality of inner chain links and a plurality of chain bolts; wherein the inner chain links are attached by the chain bolts on the at least one support plate on a circular path around the axis of the respective central wheel; and wherein the inner chain links comprising two chain plates and two chain bushings connecting the chain link plates in such a way that they are spaced apart from one another in a parallel manner.

2. An epicyclic gearing having two central wheels, a central sun wheel and a central ring wheel, and at least one planet wheel; the at least one planet wheel engages simultaneously with two central wheels in order to transmit a movement of the one central wheel on to the other central wheel;
wherein the at least two central wheels are formed as chain wheels and the at least one planet wheel have at least one support plate, a plurality of inner chain links and a plurality of chain bolts; wherein the inner chain links are attached by the chain bolts on the at least one support plate on a circular path around the axis of the respective planet wheel; and
wherein the inner chain links comprising two chain plates and two chain bushings connecting the chain link plates in such a way that they are spaced apart from one another in a parallel manner.

3. The epicyclic gearing according to claim 1, wherein at least two planet wheels are provided.

4. The epicyclic gearing according to claim 1, wherein at least three planet wheels are provided.

5. The epicyclic gearing according to claim 3, wherein the at least two planet wheels engage with a phase shift with the two central wheels.

6. The epicyclic gearing according to claim 1, wherein a second support plate is provided, wherein the chain bolts are further attached to the second support plate at periodic intervals on a circular path around the axis of the second support plate, and wherein the second support plate is arranged spaced apart from the at least one support plate in a parallel manner.

7. The epicyclic gearing according claim 1, wherein the inner chain links furthermore have a plurality of chain rollers, wherein the chain rollers are arranged such that they can rotate around the respective chain bushings.

8. The epicyclic gearing according to claim 7, wherein the respective chain wheels are formed to engage the chain rollers of the inner chain links.

9. The epicyclic gearing according to claim 1, wherein each planet wheel revolves around the axis of the two central wheels.

10. The epicyclic gearing according to claim 2, wherein at least two planet wheels are provided.

11. The epicyclic gearing according to claim 10, wherein the at least two planet wheels engage with a phase shift with the two central wheels.

12. The epicyclic gearing according to claim 2, wherein at least three planet wheels are provided.

13. The epicyclic gearing according to claim 2, wherein a second support plate is provided, wherein the chain bolts are further attached to the second support plate at periodic intervals on a circular path around the axis of the second support plate, and wherein the second support plate is arranged spaced apart from the at least one support plate in a parallel manner.

14. The epicyclic gearing according to claim 2, wherein the inner chain links furthermore have a plurality of chain rollers, wherein the chain rollers are arranged such that they can rotate around the respective chain bushings.

15. The epicyclic gearing according to claim 14, wherein the respective chain wheels are formed to engage the chain rollers of the inner chain links.

16. The epicyclic gearing according to claim 2, wherein each planet wheel revolves around the axis of the two central wheels.
